(19) United States
(12) Patent Application Publication
(10) Pub. No.: US 2009/0172727 A1
(43) Pub. Date: Jul. 2, 2009

(54) SELECTING ADVERTISEMENTS TO PRESENT

(75) Inventors: Shumeet Baluja, Leesburg, VA (US); Yushi Jing, Mountain View, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/966,616

(22) Filed: Dec. 28, 2007

(51) Int. Cl. H04N 7/10

(52) U.S. Cl. 725/34

(57) ABSTRACT

A request to select sponsored content to be presented with a first content item including video is received. A second content item including video is identified. The video included in the second content item has been viewed by at least one viewer of the video included in the first content item. Sponsored content that has been presented with the second content item is identified and selected to be presented with the first content item is selected.

### TECHNICAL FIELD

This disclosure is generally related to advertising.

### BACKGROUND

Online video is a growing medium. The popularity of online video services reflect this growth. Advertisers see online video as a way to reach their customers. Many advertisers are interested in maximizing the number of actions (e.g., impressions and/or click-throughs) for their advertisements. To achieve this, advertisers make efforts to target advertisements to content, such as videos, that are relevant to their advertisements.

When an advertiser wishes to target advertisements to a video, the advertiser may target advertisements to the video content. For example, if videos are classified into categories, the advertiser can target advertisements to the videos based on the categories.

### SUMMARY

In one general aspect, an advertisement is selected by using a data store for advertisement presentment information including information that identifies advertisements that have been presented with videos and that enables identification of one or more advertisements that have been presented with a video to be identified and a data store for video viewer information that enables identification of two or more videos that have been viewed by same viewers. A request to select an advertisement to be presented with a first video is received. The data store for video viewer information is accessed to identify a second video that has been viewed by at least one viewer of the first video. The data store for advertisement presentment information is accessed to identify an advertisement that has been presented with the second video. The identified advertisement is selected to be presented with the first video.

Implementations may include one or more of the following features. For example, identifying a second video that has been viewed by at least one viewer of the first video may include identifying a second video that has been viewed by more viewers of the first video than other videos that have been viewed by at least one viewer of the first video. The advertisement may be a first advertisement. The data store for video viewer information may be accessed to identify a third video that has been viewed by at least one viewer of the first video. The data store for advertisement presentment information may be accessed to identify a second advertisement that has been presented with the third video. The first advertisement for presentation with the first video may be identified conditioned upon a determination that the second video has been viewed by more viewers of the first video than the third video.

A first viewer-strength value may be assigned to the second video where the first viewer-strength value represents a number of viewers who viewed both the second video and the first video. A second viewer-strength value may be assigned to the third video where the second viewer-strength value represents a number of viewers who viewed both the third video and the first video. The first advertisement may be identified for presentation with the first video based on the first viewer-strength value and the second viewer-strength value.

A first normalizing value may be determined by dividing the number of viewers who viewed both the third video and the first video by the number of viewers who viewed either the third video and the first video. A second normalizing value may be determined by dividing the number of viewers who viewed both the second video and the first video by the number of viewers who viewed either the second video and the first video. The first advertisement for presentation with the first video may be identified based on a ratio of the second viewer-strength value to the second normalizing value. The second advertisement for presentation with the first video may be identified based on a ratio of the third viewer-strength value to the first normalizing value. Presentation of the selected advertisement with the first video may be enabled.

The data store for advertisement presentment information may be accessed to identify an advertisement comprises accessing the data store for advertisement presentation to identify advertisements that has been presented with the second video. Selecting the identified advertisement to be presented with the first video may include selecting one or more of the identified advertisements to be presented with the first video based on a number of available advertising slots associated with the first video.

Accessing the data store for advertisement presentment information to identify an advertisement may include accessing the data store for advertisement presentation to identify advertisements that has been presented with the second video. A value may be associated with each of the identified advertisements, where the value representing a number of times the advertisement has been presented with the second video. Selecting the identified advertisement to be presented with the first video may include selecting one or more of the identified advertisements to be presented with the first video based on number of times the advertisement has been presented with the second video.

An advertisement may be extracted from a third video. The advertisement presentment information may be modified to reflect information about the extracted advertisement, which may include matching the extracted advertisement to an advertisement in the advertisement presentment information.

The first video may be identified to an advertiser associated with selected advertisement, and presentation of the selected advertisement with the first video may be enabled only after the advertiser indicates the selected advertisement is to be presented with the first video.

In another general aspect, a request to select sponsored content to be presented with a first content item including video is received. A second content item including video is identified. The video included in the second content item has been viewed by at least one viewer of the video included in the first content item. Sponsored content that has been presented with the second content item is identified and selected to be presented with the first content item is selected. Implementations may include one or more of the features noted above or any of the features noted below.

In yet another general aspect, information defining a graph representing relationships between videos is accessed from computer-accessible storage. The graph includes nodes where a node represents a video and one or more of the nodes are associated with one or more advertisements. The graph includes edges where an edge is connected to two videos and represents a number of viewers who saw both videos to which the edge is connected. The graph is used to associate an advertisement with a first node based on the advertisement being associated with a second node that is connected by an edge with the first node.

Implementations may include one or more of the features noted above and one or more of the following features. The graph may be used to associate an advertisement with a first node comprises searching the graph using a breadth-first search technique.

Implementations of the techniques discussed above may include a method or process, a system or apparatus, or computer software on a computer-accessible medium. The details of one or more of the implementations are set forth in the accompanying drawings and description below. Other features and advantages will be apparent from the description and drawings as well as from the claims.

### BRIEF DESCRIPTION OF THE DRAWINGS

FIG. 1 illustrates an example of an environment for providing video and advertisement content.

FIG. 2A is an example of data associating pairs of videos to the number of viewers which have viewed both videos in a pair of videos.

FIG. 2B is an example of data associating advertisements and advertisers to videos.

FIG. 3 is a flow diagram of an example process for selecting advertisements to present with videos.

FIG. 4A is a block diagram illustrating a mapping of users to videos viewed.

FIG. 4B is a block diagram illustrating a video receiving advertisements from another video based upon shared viewers.

FIG. 5A is a block diagram illustrating a mapping of users to videos viewed.

FIG. 5B is a block diagram illustrating a video receiving advertisements from another video based upon shared viewers.

FIG. 6 is a flow diagram of an example process for relating advertisers to video content.

FIG. 7 is a block diagram illustrating an example generic computer.

### DETAILED DESCRIPTION

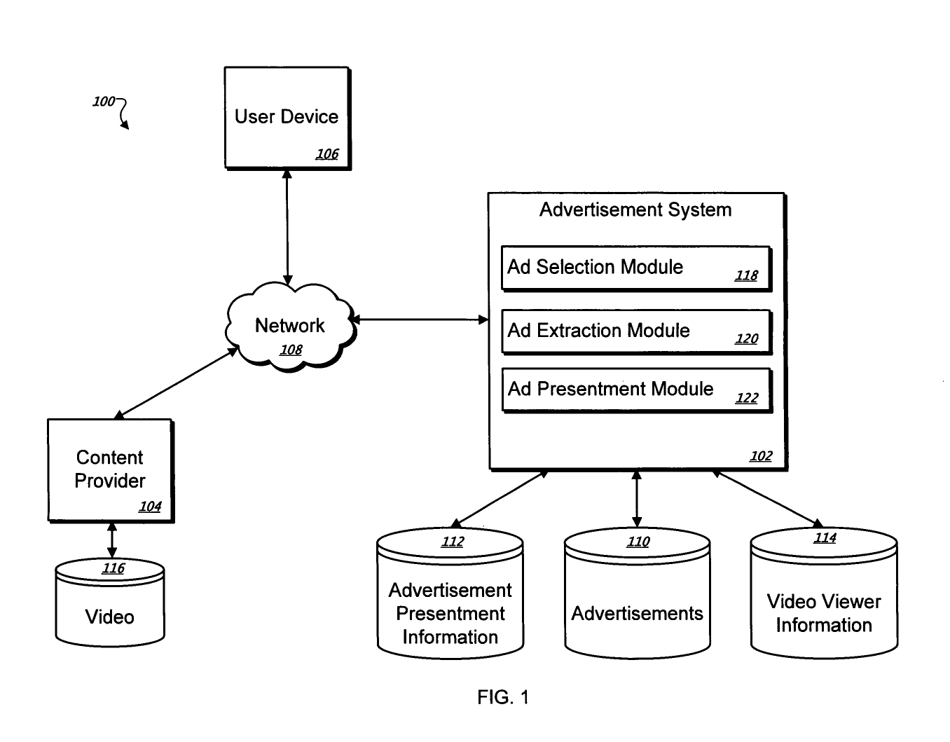

FIG. 1 shows an example of an environment 100 for providing content. The content, or “content items,” can include various forms of electronic media. For example, the content can include text, audio, video, advertisements, configuration parameters, documents, video files published on the Internet, television programs, podcasts, video podcasts, live or recorded talk shows, video voicemail, segments of a video conversation, and other distributable resources.

The environment 100 includes, or is communicably coupled with, an advertisement system 102, a content provider 104, and one or more user devices 106, at least some of which communicate across a network 108. In general, the advertisement system 102 can relate content for presentation with other identified content and provide relevant advertising content (“ad content”) or other relevant content based upon the ad content associated with the identified content. By way of example, reference is made to delivering ad content, though other forms of content (e.g., other content item types) can be delivered, including other forms of sponsored content.

The presented content can be provided by the content provider 104 from a content repository 116 through the network 108. The ad content can be distributed through the network 108 to one or more user devices 106 before, during, or after presentation of the material.

In some implementations, the advertisement system 102 may be coupled with an ad repository 110. The ad repository 110 stores advertisements that can be presented with various types of content, including audio and/or video content. The advertisement system 102, in some implementations, may also be coupled with an advertisement presentment information repository 112 and/or a video viewer information repository 114.

In some implementations, the environment 100 may be used to identify relevant advertising content according to a particular selection of a video or audio content item (e.g., one or more segments of video or audio). The advertisement system 102 can use information about the number of viewers who viewed both a first and a second video (which may be referred to as a video preference mapping) and store the video preference mappings, for example, within the video viewer information repository 114. In one example, the video content item may be available through the content provider 104 from within the content repository 116 using a user access identifier (e.g., user identification and password, etc.). The content provider 104 could, in this example, track the video content items requested by each user (e.g., within the content repository 116 or another local, external, or remote storage device). Using this information, data can be generated on the number of viewers who requested both a first and a second video. These video pair mappings, anonymous of identity of the individual viewers, can be shared with the advertisement system 102 and stored within the video viewer information repository 114 for use in targeting advertisements. In some implementations, the number of times that a video content item was viewed by a particular (though anonymous) viewer can also be calculated into the video pair mappings data.

Information regarding the advertisement content associated with the video content items can be stored within the ad presentment information repository 112. The ad presentment information repository 112, for example, can include mapping information between individual video content items and one or more advertisement content items associated with the video content item. In some implementations, advertisements can be detected within video content items, extracted, and matched to known advertisements and/or advertisers. For example, advertisement detection and extraction can be performed using any suitable manual or automatic means, such as by detecting silence and/or blank images that occur before the start of a commercial segment in television broadcasts, matching visual and acoustic representations within a video to detect advertisements that are repeated during the video.

Once advertisements have been extracted, they can be matched to known advertisements and/or advertisers using manual and/or automatic methods (e.g., using machine comparison of video images, audio track, and/or closed captioning text, video metadata identification, manual identification, audio fingerprinting techniques, etc.). An ad extraction module 120 within the advertisement system 102, for example, can extract ads from video content items and match them with the advertisements stored within the ad repository 110.

The information associating advertisements with videos and the users who have viewed particular videos can be used, in some implementations, to select relevant advertisements from the ad repository 110 for appropriate placement with a video content item or to include with other video content items which share relevance with the video content item mapped to the advertisements. For example, the advertisements extracted from a video content item can be replaced by more recent advertisements available from the same advertiser. In some implementations, an ad selection module 118 can associate ads with a video content item based upon records within the ad presentment information repository 112. In another example, one or more advertisement items associated with a second video content item can be provided along with a first video content item based upon the likelihood that a viewer of the second video content item would also be interested in viewing the first video content item (e.g., based upon information within the video viewer information repository 114). The ad selection module 118 may select one or more advertisements and/or advertisers associated with one or more video content items which are identified as being relevant to the requested video content item. The selected advertisements can then be presented with the requested video content item, for example by an ad presentment module 122. In some implementations, the relevant advertisements can be placed in proximity to or overlaid with the presented video content item, such as in a banner, sidebar, or frame. For example, the ad presentment module 122 can correlate advertisements within or in proximity of the requested video content item.

In some implementations, the selection of advertisements for presentation with a video content item can be determined, in part, by identifying the video content items most frequently viewed by the same viewers selecting to view the video content item to be presented. For example, a portion of the viewers who viewed a first video containing dog training tips may have also chosen to view a second video containing dog obedience training. If the first video contains advertisements and the second video does not, the second dog obedience training video could be associated with one or more advertisements from the first dog training video for display or presentment with the second dog obedience training video.

A portion of the viewers of the second dog obedience video may, as a further example, have also viewed a third video containing dog agility demonstrations. If the third agility video is also associated with advertisements, the second video may additionally be associated with one or more advertisements from the third video. In some implementations, association of advertisements from multiple sources can depend upon the shared number of viewers of each video pair (first-second, third-second). In some examples, a normalized weighting of the number of shared viewers of each video pair, a threshold percentage of viewers shared, and/or a weighting by number of times viewed by number of viewers could be used to determine the number of advertisements to receive from (or otherwise associate with) each video source. Any number of videos can contribute advertisements to a related video.

Advertisers may be offered to purchase placement of advertisements in videos, in some implementations, based upon advertisement association with relevant video content. The offer to purchase placement of an advertisement in a video may be referred to as marketing the advertiser. In one example, a portion of the viewers of a first baseball bloopers video may also choose to view a second sports bloopers video. If a sports drink advertisement presented with the first baseball bloopers video is associated with a beverage advertiser, the beverage advertiser can be marketed to include the sports drink advertisement or another advertisement during presentment of the second sports bloopers video. In some implementations, the marketing can be applied automatically, for example within a computer-based advertiser bidding system. If, for example, an advertiser bids on a particular video content item, the bidding system can provide one or more additional video content items for the advertiser to bid on based upon user preference associated with the video pairs.

The system 100 may contain more or fewer elements, and the elements within the system 100 can be organized in a different manner than illustrated. The video viewer information repository 114, in some implementations, can be stored by the content provider 104. For example, the content provider 104, within a request for advertisement content, could include one or more additional video content items related to the requested video content item. Using the information provided by the content provider, the ad selection module 118 could identify advertisements associated with the related videos (e.g., within the ad presentment information repository 112) and present one or more of those advertisements using the ad presentment module 122. In some implementations, the ad extraction module 120 may be included within the content provider 104. The extracted advertisement information, for example, could be shared with the advertisement system 102 by the content provider 104 (e.g., to populate the ad presentment information repository 112).

In some implementations, a “video content item” is an item of content that includes content that can be perceived visually when played, rendered, or decoded. A video content item includes video data, and optionally audio data and metadata. Video data includes content in the video content item that can be perceived visually when the video content item is played, rendered, or decoded. Audio data includes content in the video content item that can be perceived aurally when the video content item is played, decoded, or rendered. A video content item may include video data and any accompanying audio data regardless of whether or not the video content item is ultimately stored on a tangible medium. A video content item may include, for example, a live or recorded television program, a live or recorded theatrical or dramatic work, a music video, a televised event (e.g., a sports event, a political event, a news event, etc.), video voicemail, etc. Each of different forms or formats of the same video data and accompanying audio data (e.g., original, compressed, packetized, streamed, etc.) may be considered to be a video content item (e.g., the same video content item, or different video content items). A video content item may include text, such as text that can be rendered as an image or a sequence of images.

Video content can be consumed at various client locations, using various devices. Examples of the various devices include customer premises equipment which is used at a residence or place of business (e.g., computers, video players, video-capable game consoles, televisions or television set-top boxes, etc.), a mobile telephone with video functionality, a video player, a laptop computer, a set top box, a game console, a car video player, etc. Video content may be transmitted from various sources including, for example, terrestrial television (or data) transmission stations, cable television (or data) transmission stations, satellite television (or data) transmission stations, via satellites, radio cell towers, and video content servers (e.g., Webcasting servers, podcasting servers, video streaming servers, video download Websites, etc.). Video content may be transmitted via a network such as the Internet or a video phone service provider network such as the Public Switched Telephone Network (“PSTN”), for example.

A video content item can also include many types of associated data. Examples of types of associated data include video data, audio data, closed-caption or subtitle data, a transcript, content descriptions (e.g., title, actor list, genre information, first performance or release date, etc.), related still images, user-supplied tags and ratings, etc. Some of this data, such as the description, can refer to the entire video content item, while other data (e.g., the closed-caption data) may be temporally-based or timecoded. In some implementations, the temporally-based data may be used to detect scene or content changes to determine relevant portions of that data for targeting ad content to users.

In some implementations, an “audio content item” is an item of content that can be perceived aurally when played, rendered, or decoded. An audio content item includes audio data and optionally metadata. The audio data includes content in the audio content item that can be perceived aurally when the video content item is played, decoded, or rendered. An audio content item may include audio data regardless of whether or not the audio content item is ultimately stored on a tangible medium. An audio content item may include, for example, a live or recorded radio program, a live or recorded theatrical or dramatic work, a musical performance, a sound recording, a televised event (e.g., a sports event, a political event, a news event, etc.), voicemail, etc. Each of different forms or formats of the audio data (e.g., original, compressed, packetized, streamed, etc.) may be considered to be an audio content item (e.g., the same audio content item or different audio content items).

Audio content can be consumed at various client locations, using various devices. Examples of the various devices include customer premises equipment which is used at a residence or place of business (e.g., computers, audio players, audio-capable game consoles, televisions or television set-top boxes, etc.), a mobile telephone with audio playback functionality, an audio player, a laptop computer, a car audio player, etc. Audio content may be transmitted from various sources including, for example, terrestrial radio (or data) transmission stations, via satellites, and audio content servers (e.g., Webcasting servers, podcasting servers, audio streaming servers, audio download Websites, etc.). Audio content may be transmitted via a network such as the Internet or a video phone service provider network such as the Public Switched Telephone Network (“PSTN”), for example.

An audio content item can also include many types of associated data. Examples of types of associated data include audio data, a transcript, content descriptions (e.g., title, actor list, genre information, first performance or release date, etc.), related album cover image, user-supplied tags and ratings, etc. Some of this data, such as the description, can refer to the entire audio content item, while other data (e.g., the transcript data) may be temporally-based. In some implementations, the temporally-based data may be used to detect scene or content changes to determine relevant portions of that data for targeting ad content to users.

Ad content can include text, graphics, still-images, video, audio, audio and video, banners, crawlers, links (such as advertising providing a hyperlink to an advertiser's website), and other web or television programming related data. As such, ad content can be formatted differently, based on whether the ad content is primarily directed to websites, media players, email, television programs, closed captioning, etc. For example, ad content directed to a website may be formatted for display in a frame within a web browser. In other examples, ad content may be delivered in an RSS (Real Simple Syndication) feed, or ad content may be delivered relative to a radio item (such as before, during or after a radio item). As yet another example, ad content directed to a video player may be presented “in-stream” as video content is played in the video player. In some implementations, in-stream ad content may replace the video or audio content in a video or audio player for some period of time or may be inserted between portions of the video or audio content. An in-stream advertisement can be placed pre-roll, post-roll, or mid-roll relative to video feature content. An in-stream advertisement may include video, audio, text, animated images, still images, or some combination thereof.

An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in electronic press or a broadcast. An ad may be referred to or include sponsored content.

The content provider 104 can present content to users (e.g., through user device 106) over the network 108. In some implementations, the content providers 104 are web servers where the content includes webpages or other content written in the Hypertext Markup Language (HTML), or any language suitable for authoring webpages. In general, the content provider 104 can include users, web publishers, and other entities capable of distributing content over a network. For example, a web publisher may create an MP3 audio file and post the file on a publicly available web server. In some implementations, the content provider 104 may make the content accessible through a known Uniform Resource Locator (URL).

The content provider 104 can receive requests for content (e.g., articles, discussion threads, music, audio, video, graphics, search results, webpage listings, etc.). The content provider 104 can retrieve the requested content in response to, or otherwise service, the request. The advertisement system 102 may broadcast content as well (e.g., not necessarily responsive to a request).

A request for advertisements (or “ad request”) may be submitted to the advertisement system 102. Such an ad request may include ad spot information (e.g., a number of advertisements desired, a duration, type of ads eligible, etc.). In some implementations, the ad request may also include information about the content item that triggered the request for the advertisements. This information may include the content item itself (e.g., a page, a video file, a segment of an audio stream, data associated with the video or audio file, etc.), one or more categories or topics corresponding to the content item or the content request (e.g., arts, business, computers, arts-movies, arts-music, etc.), part or all of the content request, content age, content type (e.g., text, graphics, video, audio, mixed media, etc.), geo-location information, etc.

Content provided by the content provider 104 can include news, weather, entertainment, or other consumable textual, audio, or video media. More particularly, the content can include various resources, such as documents (e.g., web pages, plain text documents, Portable Document Format (PDF) documents, images), video or audio clips, etc. In some implementations, the content can be graphic-intensive, media-rich data, such as, for example, Flash-based content that presents video and sound media.

The environment 100 includes one or more user devices 106. The user device 106 can include a desktop computer, laptop computer, a media player (e.g., an MP3 player, a streaming audio player, a streaming video player, a television, a computer, a mobile device, etc.), a mobile phone, a browser facility (e.g., a web browser application), an e-mail facility, telephony means, a set top box, a television device, a radio device or other device that can access advertisements and other content via the network 108. The content provider 104 may permit the user device 106 to access content (e.g., video files for downloading or streaming, audio files for downloading or streaming, etc.).

The network 108 facilitates wireless or wireline communication between the advertisement system 102, the content provider 104, and any other local or remote computers (e.g., user device 106). The network 108 may be all or a portion of an enterprise or secured network. In another example, the network 108 may be a virtual private network (VPN) between the content provider 104 and the user device 106 across a wireline or a wireless link. While illustrated as a single or continuous network, the network 108 may be logically divided into various sub-nets or virtual networks without departing from the scope of this disclosure, so long as at least a portion of the network 108 may facilitate communications between the advertisement system 102, content provider 104, and at least one client (e.g., user device 106). In certain implementations, the network 108 may be a secure network associated with the enterprise and certain local or remote clients 106.

Examples of the network 108 include a local area network (LAN), a wide area network (WAN), a wireless phone network, a Wi-Fi network, and the Internet.

In some implementations, the content item is combined with one or more of the advertisements provided by the advertisement system 102. This combined information including the content of the content item and advertisement(s) is then forwarded toward a user device 106 that requested the content item or that configured itself to receive the content item for presentation to a user.

The content provider 104 may transmit information about the ads and how, when, and/or where the ads are to be rendered, and/or information about the results of that rendering (e.g., ad spot, specified segment, position, selection or not, impression time, impression date, size, temporal length, volume, conversion or not, etc.) back to the advertisement system 102 through the network 108. Alternatively, or in addition, such information may be provided back to the advertisement system 102 by some other means.

In some implementations, the content provider 104 includes advertisement media as well as other content. In such a case, the advertisement system 102 can determine and inform the content provider 104 which advertisements to send to the user device 106, for example.

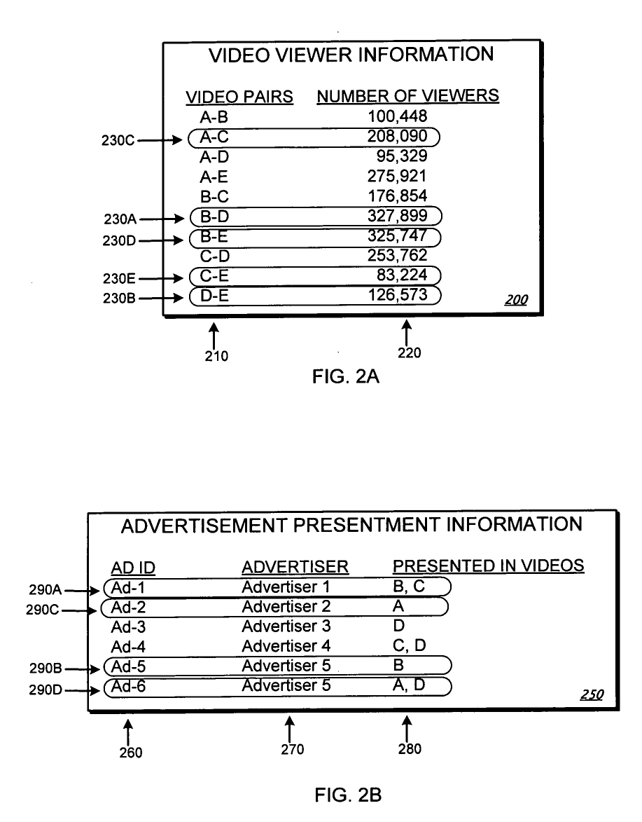

FIG. 2A is an example of data 200 associating pairs of videos to the number of viewers who have viewed both videos in a pair of videos. The example data 200 is presented for five videos identified as A, B, C, D, and E. For the five videos in the example data 200, there are ten possible combinations of two videos, which may be referred to as a video pair or pair. The ten pairs of videos in the data 200 are shown in column 210: A-B, A-C, A-D, A-E, B-C, B-D, B-E, C-D, C-E, and D-E. The data 200 includes, as shown in column 220, the number of viewers who have viewed both of the videos within each pair. The total number of viewers who have viewed both videos within a pair can also be referred to as the viewer-strength value of the pair. Using the information presented within the data 200, the likelihood of a user being interested in both a first and a second video may be discernable. In some implementations, the data 200 describes data stored within the video viewer information repository 114 (FIG. 1). The data may be stored, for example, within a relational database management system (RDBMS) accessible through queries. In some implementations, the viewer-strength value weighs the number of times each viewer viewed both videos.

For example, the video pair B-D share a common viewership of 327,899 viewers (as illustrated in row 230A), the largest number of the possible video pair combinations shown in the data 200. Based upon the viewer-strength value of video pair B-D, a viewer who enjoys video B may be likely to also be interested in video D and vice-versa. Conversely, the video pair D-E share the least number of common viewers, 83,224, as illustrated in row 230B. Considering the relatively low number of viewers who have viewed both video D and video E, it may be unlikely that viewers interested in video D will also be interested in video E and vice-versa.

The relationship of the viewers interested in particular types of videos can be described as the viewership demographic. For example, viewers interested in children's cartoons are in a different demographic (e.g., a young age range demographic) compared to viewers interested in videos related to retirement investing. Advertisers may try to market certain advertisements to certain demographics. For example, an advertisement for a new toy could be presented to the young age range demographic rather than the retirement demographic.

Using the data 200, advertisements presented with a first video can be selected to be presented with a second video based upon viewers' shared interest of the two videos. For example, advertisements associated with video E could be selected for presentment with video A, because the largest number of shared viewers of any video with video A is video E at 275,921, as illustrated by row 230C. The shared interest value can, in some implementations, be weighted by the number of times each viewer viewed both of the videos within the pair. In some implementations, the advertisements can be selected for presentment using the information stored within the ad presentment information repository 112 (FIG. 1).

FIG. 2B is an example of data 250 associating advertisements and advertisers with videos. The example data 250 may be referred to as mapping advertisements and advertisers with videos. As illustrated in the data 250, six advertisements (identified as Ad-1 through Ad-6) are shown in column 260, five advertisers (identified as Advertiser 1 through Advertiser 5) are shown in column 270, and four videos (identified as A through D) are shown in column 280. As such, the example data 250 shows the association, relationship or mapping between five advertisers (i.e., Advertiser 1 through Advertiser 5) and four videos (i.e., A through D). For example, a particular advertisement associated with a particular advertiser is mapped as being presented within one or more videos. Using the data 250, the advertisement(s) associated with a particular video can be located. In some implementations, the data 250 describes data stored within the ad presentment information repository 112 (FIG. 1). The data may be stored, for example, within an RDBMS accessible through queries. In some implementations, advertisement presentment information may not include the advertiser associated with each advertisement (as illustrated in column 270 of the data 250). The number of times each ad is presented within a particular video, in some implementations, can also be tracked within the advertisement presentment information.

Using the data 250, advertisements associated with a first video can be selected for presentment with a second video. For example, referring to the data 200, the advertisements associated with video B can be selected for presentment with video E, because the largest number of shared viewers for any video pair including video E is video B. The B-E video pair share 325,747 viewers, as illustrated in row 230D (FIG. 2A). The data 250 indicates that advertisements Ad-1 and Ad-5 are presented within the video B (as illustrated by rows 290A and 290B). In presenting video E, the advertisements Ad-1 and Ad-5 can be selected for presentment based on the relationship between video B with Ad-1 and Ad-5.

If, as a further example, video E contains three available slots for advertisements, a second video correlation can be used to select additional advertisements for video E. According to the data 200, the second largest number of viewers of both video E and another video is the A-E video pair with 275,921 shared viewers, as illustrated by row 230C (FIG. 2A). In reference to the data 250, both Ad-2 and Ad-6 are presented with video A, as illustrated by rows 290C and 290D. In this example, either Ad-2 or Ad-6 can be selected for presentment with video E along with Ad-1 and Ad-5. Because both Ad-5 and Ad-6 are associated with the same advertiser (e.g., Advertiser 5), preference could be given to the selection of Ad-2.

In some implementations, other types of information about the relationships between viewers and videos may be stored. More complex relationships between viewers and videos may be determined and stored. For example, all the viewers who have seen videos A and B, a determination may be made as to how many viewers have seen video C, how many have seen video D and/or how many have seen both video C and video D. For all the viewers who have seen videos B and C, how many have seen video A, video D and/or both video A and video D. For all the viewers who have seen videos A and C, how many viewers have seen video B, how many have seen video D and/or how many have seen both video B and video D.

In some implementations, ads can be selected from multiple associated videos using a normalized ratio of viewer preferences. For example, considering videos C, D, and E, video pair C-E share 83,224 viewers, as illustrated in row 230E (FIG. 2A), and video pair D-E share 126,573 viewers, as illustrated in row 230B (FIG. 2A). The ratio of each video pair to the total number of viewers between both video pairs provides a weighted value to apply to advertisement selection. The total number of viewers who viewed both video C and video E (e.g., 83,224) added to the total number of viewers who viewed both video D and video E (e.g., 126,573) generates a normalizing value (e.g., 209,797). The normalizing value, in general, is the sum of all viewer-strength values of the videos being considered for contributing advertisements to the advertising slots of the identified related video. Individual viewer-strength values can be divided by the normalizing value to generate a ratio. In terms of the C-E pair, the ratio of viewer-strength value to normalizing value can be rounded to 0.4. Similarly, the ratio of the viewer-strength value of the D-E pair to the normalizing value can be rounded to 0.6. When selecting three advertisements for presentment with video E, although the viewer-strength value associated with the video pair D-E is greater than the viewer-strength value associated with the video pair C-E and video D is associated with three different advertisements, the normalizing values can be used to select advertisements associated with both video D and video C. For example, two advertisements associated with video D (e.g., Ad-3 and Ad-6) can be presented with video E along with one advertisement associated with video C (e.g., Ad-1). Although the example takes into consideration two video pairs, any number of video pairs can be considered when applying the normalizing ratios of viewer preferences to advertisement selection.

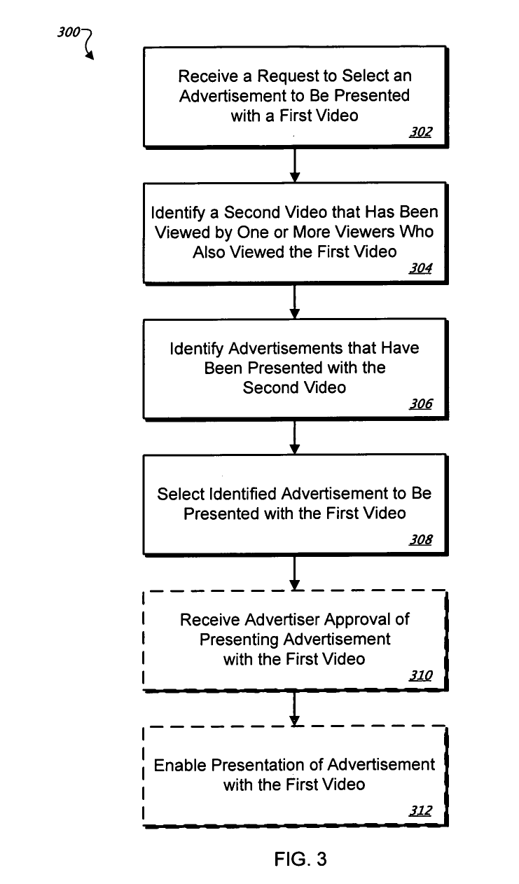

FIG. 3 illustrates an example process 300 for selecting advertisements to present with videos. The process 300 can, in some implementations, be carried out by the system 100 as described in FIG. 1. The process 300 begins at step 302 by receiving a request to select an advertisement to be presented with a first video. For example, the advertisement system 102 could receive an advertisement request from the content provider 104. The advertisement request can contain information regarding the first video (e.g., identification, category, length, number of advertisement slots, the video itself, etc.). The advertisement request, in some implementations, may also contain information regarding the advertisement(s) desired (e.g., length, placement, capabilities, etc.).

Using the information regarding the first video, a second video is identified that has been viewed by one or more of the viewers who has also viewed the first video (step 304). The ad selection module 118, for example, could locate viewer-strength values associated with the first video and one or more additional videos within the video viewer information repository 114. The second video could be chosen based upon the highest viewer-strength value identified amongst all videos which share viewers with the first video.

Advertisements are identified that have been presented with the second video (step 306). For example, the ad selection module 118 could locate the advertisement(s) associated with the second video within the ad presentment information repository 112. Any number of advertisements may be associated with the second video. In some implementations, along with the advertisement, the advertiser associated with the advertisement may be identified and/or the number of times the advertisement is displayed within the second video.

An identified advertisement is selected to be presented with the first video (step 308). For example, the selected advertisement may be associated with the second video. The selected advertisement may, in another example, be associated with the advertiser of an advertisement being presented with the second video. For example, a more recent advertisement may be available for the same advertiser. Rather than using the advertisement associated with the second video, the most recent advertisement associated with the advertiser can be selected for presentation with the first video. More than one advertisement can be selected for presentation with the first video. If there are multiple advertisements associated with the second video, selection of an advertisement for presentation with the first video can be based, in part, upon the advertiser's bid price, the advertisement slot available within the first video, information regarding the first video (e.g., keyword match, etc.), etc. In some implementations, the selection of which ad to show may be based on the success of the advertisement. For example, an ad that was more successful may be selected over less successful ads. Success of an ad can be measured, for example, based on the number of sales or another type of response, such as a viewer clicking on a link provided in or with the advertisement to obtain additional information or view an advertiser's web site. Optionally, advertiser approval for presenting the advertisement with the first video is received (step 310). In some implementations, the advertiser can be notified (e.g., over network 108) of an advertisement being selected for presentation within an additional video. The advertiser, for example, may be given the opportunity to select a different advertisement for presentation with the first video. If, for example, the advertisement associated with the second video contains references to winter sports and the season is presently summer, the advertiser may choose to instead present an advertisement containing reference to summer activities. The advertiser may, in another example, be given the opportunity to bid on the placement of the advertisement within an the identified video.

Optionally, presentation of the selected advertisement with the first video is enabled (step 312). The first video, in some implementations, receives the selected advertisement from the second video for presentation when the first video is viewed. For example, the first video could be associated with the selected advertisement for a certain period of time (e.g., one week, thirty days, etc.). In other examples, the first video could gain an association with the advertiser of the selected advertisement, and the selected advertisement can be enabled for presentation. By enabling the advertisement for presentation, in some implementations the advertisement could receive a placement within the identified video (e.g., timeslot, spatial positioning), the advertisement and/or the advertisement information may be forwarded to a content provider, etc.

In some implementations, information such as the records described in the video viewer information data 200 (FIG. 2A) can be used to identify a second video which has been viewed by one or more viewers who also viewed the first video. Once the second video has been identified, information such as the records described within the advertisement presentment information data 250 (FIG. 2B) can be used to associate the identified video with one or more advertisements and/or advertisers. Using the identified second video and advertisements associated with the second video, an advertisement can be chosen, for example by the ad selection module 118 of the advertisement system 102, to be included within the presentation of the first video.

Although the steps in the process 300 have been presented linearly, the steps may occur in more than one communication or computing session or otherwise asynchronously. For example, steps 302 to 308 may occur in one session and the selected advertisement may be presented to an advertiser in another session, during which approval is received (step 310). In yet another communication or computing session, the advertisement may be placed within or otherwise associated with the first video, or the advertisement may be transmitted for presentation to a viewer of the first video (step 312).

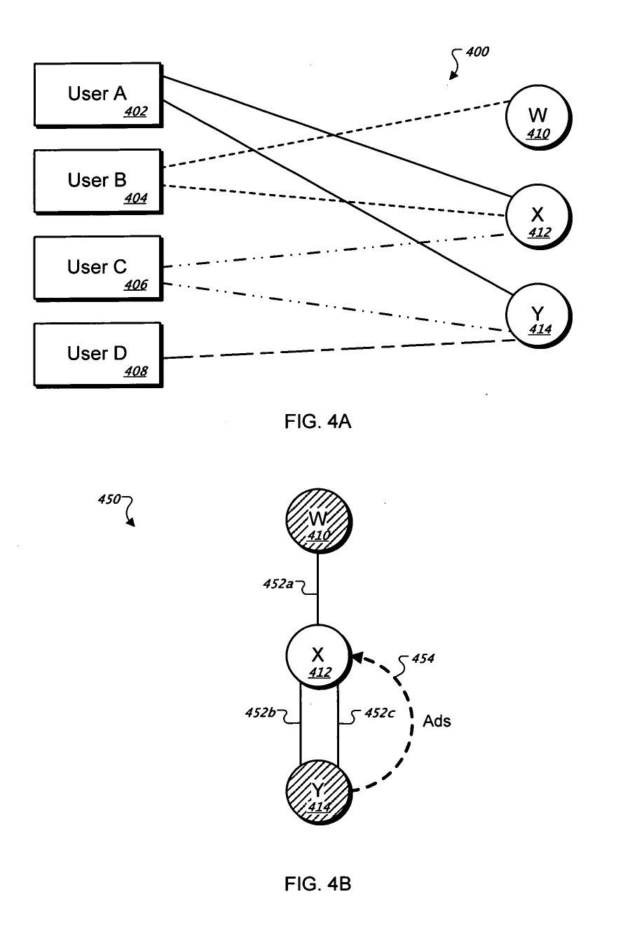

FIG. 4A depicts a mapping 400 of users to videos viewed. Four users (identified as User A 402, User B 404, User C 406 and User D 408) are mapped to the viewing of three videos (identified as video W 410, video X 412 and video Y 414). A first user A 402 is connected to a video X 412 and a video Y 414, as shown by solid lines 420 and 422, respectively. A line also may be referred to as an edge. A second user B 404 is connected to a video W 410 and the video X 412, as shown by dashed lines 424 and 426, respectively. A third user C 406 is connected to the video X 412 and the video Y 414, as shown by lines 428 and 430, respectively. A fourth user D 408 is connected to the video Y 414, as shown by line 432.

Based upon the mapping 400, some information can be discerned regarding the shared interests of the viewers. For example, user A 402 and user C 406 each viewed both video X 412 and video Y 414. The videos X 412 and Y 414 could share a common viewer demographic. In this case, because user D 408 also viewed video Y 414, it could be suggested, for example, that user D 408 may also enjoy video X 412. The mapping 400 could be a visualization generated from information similar to the records contained within the video viewer information data 200 (FIG. 2A).

Using the relationships between users and videos within the mapping 400, FIG. 4B shows a graphical representation 450 for a video receiving (or otherwise being associated or related to) advertisements from another video based upon shared viewers. The nodes W 410, X 412, and Y 414 (e.g., representing corresponding videos also shown in FIG. 4A) are connected by a series of lines (e.g., edges) 452. Each edge 452a, 452b and 452c represents, for example, a user who viewed of the both videos which are connected by one of the edges 452a, 452b or 452c. For example, the first edge 452a, connecting node W 410 to node X 412, represents the User B 404. The second edge 452b and the third edge 452c, each connecting node X 412 to node Y 414, represent user A 402 and user C 406.

The nodes W 410 and Y 414 are illustrated as shaded circles. The shading represents videos associated with advertisements. The node X 412 is not shaded. A dotted arrow 454 points from node Y 414 towards node X 412. Because node X 412 and node Y 414 are connected by two edges 452b and 452c, node Y 414 is the a candidate for advertisement sharing with node X 412. One or more advertisements can be selected from the advertisements associated with the video represented by node Y 414 for presentation with the video represented by node X 412.

In other implementations, both the video represented by node Y 414 and the video represented by node W 410 can share advertisements with the video represented by node X 412. For example, the total number of edges 452a, 452b and 452c connected to node X 412 is three. Two thirds of the three edges 452 (i.e., edges 452b and 452c) are connected between node X 412 and node Y 414, while one third of the edges 452 (i.e., edge 452a) are connected between node X 412 and node W 410. If, for example, three slots are available for advertisements to be presented with the video represented by node X 412, two advertisements could be selected from the video represented by node Y 414 and one advertisement could be selected from the video represented by node W 410.

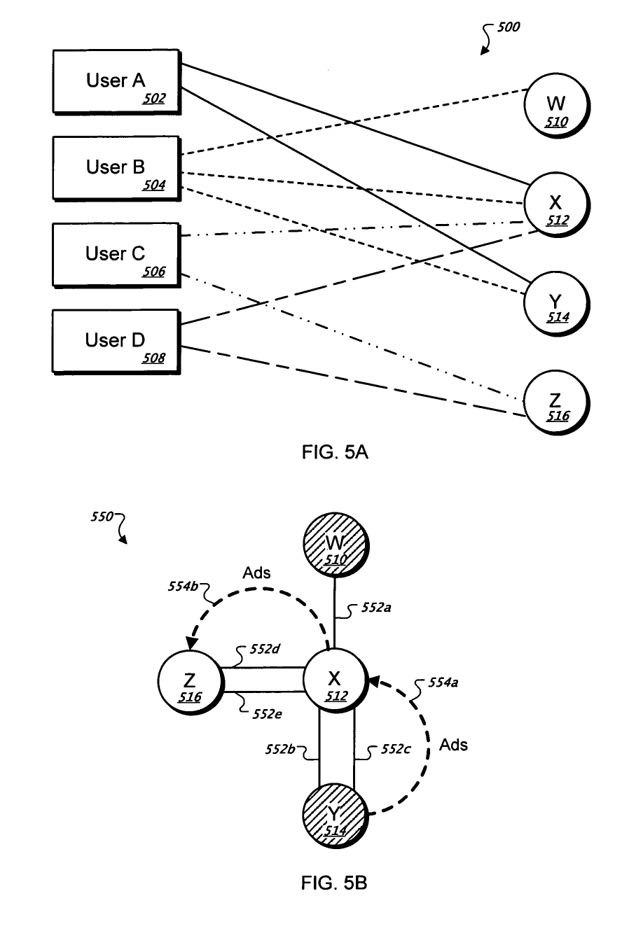

FIG. 5A illustrates a mapping 500 of users to videos viewed. Four users (identified as User A 502, User B 504, User C 506 and User D 508) are mapped to the viewing of four videos (identified as video W 510, video X 512, video Y 514 and video Z 516). A first user A 502 is connected to a video X 512 and a video Y 514, as illustrated by solid lines 520 and 522, respectively. A second user B 504 is connected to a video W 510, the video X 512, and the video Y 514, as shown by dashed lines 524, 526 and 527, respectively. A third user C 506 is connected to the video X 512 and a video Z 516, as depicted by lines 528 and 529, respectively. A fourth user D 508 is connected to the video X 512 and the video Z 516, as illustrated by lines 531 and 533, respectively.

Based upon the mapping 500, some information can be discerned regarding the shared interests of the viewers. For example, user A 502 and user B 504 each viewed both video X 512 and video Y 514. The videos X 512 and Y 514 could share a common viewer demographic. User C 506 and user D 508 each viewed both video X 512 and video Z 516. The videos X 512 and Z 516 could share a common viewer demographic. The mapping 500 could be a visualization generated from information similar to the records contained within the video viewer information data 200 (FIG. 2A).

Using the relationships between users and videos within the mapping 500, FIG. 5B illustrates a graphical representation 550 for a video receiving advertisements from another video based upon shared viewers. The nodes (e.g., representing videos) W 510, X 512, Y 514, and Z 516 are connected by a series of lines (e.g., edges) 552a, 552b, 552c, 552d and 552e. Each edge 552a, 552b, 552c, 552d and 552e represents, for example, a user who viewed both of the videos which are connected by the edge 552a, 552b, 552c, 552d or 552e. For example, the first edge 552a, connecting node W 510 to node X 512, represents the User B 504. The second edge 552b and the third edge 552c, each connecting node X 512 to node Y 514, represent user A 502 and user B 504. Similarly, the fourth edge 552d and the fifth edge 552e, each connecting node X 512 to node Z 516, represent user C 506 and user D 508.

The nodes W 510 and Y 514 are illustrated as shaded circles. The shading represents videos associated with advertisements. The nodes X 512 and Z 516 are not shaded. A dotted arrow 554a points from node Y 514 towards node X 512. Because node X 512 and node Y 514 are connected by two edges 552b and 552c, node Y 514 is a candidate for advertisement sharing with node X 512. One or more advertisements can be selected from the video represented by node Y 514 for presentation with video represented by node X 512.

Node X 512 and node Z 516 are also connected by two edges, 552d and 552e. Neither node X 512 nor node Z 516 are associated with advertisements, but if the video represented by node X 512 receives advertisement associations from node Y 514 (and/or node W 510), the video represented by node Z 516 also may inherit the same advertisement associations through the relationship with node X 512. A dotted arrow 554b illustrates the inheritance relationship from node X 512 to node Z 516. Any number of videos can receive advertisement associations for presentment in this manner.

If, for example, node Z 516 were also directly connected to node W 510 by a single edge, in some implementations, the video represented by node Z 516 may receive advertisements through the direct connection with a node associated with advertisements rather than an indirect, though stronger (e.g., two edges versus one edge) connection. In other implementations, a video may receive advertisements through both direct and indirect connections, for example using a weighted ratio algorithm. In some implementations, indirect connections may be identified by using a breadth-first-search starting from a video that needs ads and continuing until a video having ads is identified.

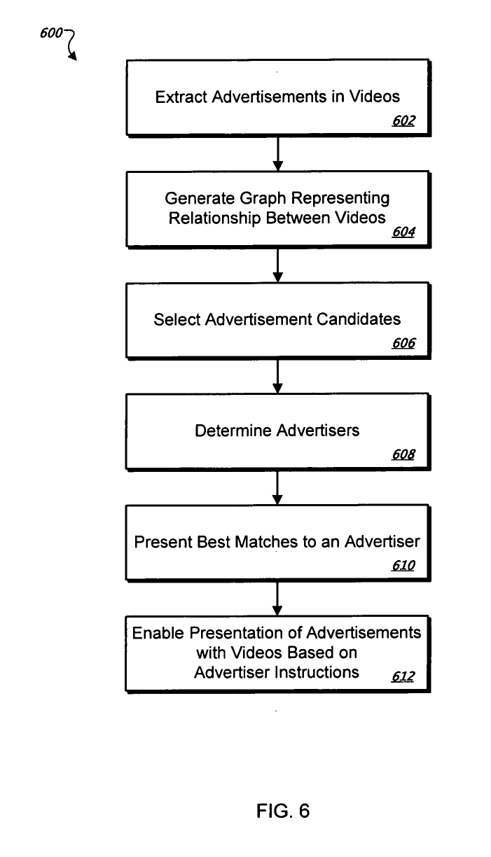

FIG. 6 is a flow diagram of an example process 600 for relating advertisers to video content. The process 600 can, in some implementations, be carried out by the system 100 as described in FIG. 1. The process 600 begins at step 602 by extracting advertisements from a group of videos. The videos, for example, can include television episodes and/or other video types containing advertising content. Any number of advertisements can be embedded within a video. The advertisements can be located by any advertisement recognition method and extracted (e.g., placed within a separate video content item). The extracted advertisements, for example, can be stored within an advertisement repository. In some implementations, duplicate advertisements can be recognized, for example such that an advertisement is only stored once. The associations between the videos and each advertisement formerly included within the video is stored (e.g., within a database, etc.).

A graph representing the relationship between the videos within the group based upon viewers having viewed both of a set of videos is generated (step 604). The graph, for example, may be similar to the graphical representations 400 of FIG. 4A and 500 of FIG. 5A. The generated graph may be depicted visually (such as representations 400 and 500) or mathematically. For example, if a viewer has viewed both a first video of a hospital drama and a second video of a police drama, the graph indicates a relationship between the hospital drama and the police drama. For example, the relationship can indicate how many viewers have viewed both the hospital drama and the police drama. In another example, the relationship also may represent the number of times an individual viewer viewed both the hospital drama and the police drama. In some implementations, the graph may indicate a relationship between a series (e.g., a collection of television episode series, a season of television episodes, or a movie trilogy) in addition to or in lieu of a relationship between individual videos.

Advertisement candidates are selected from the group of videos for any videos which did not contain advertisements (step 606). For example, the hospital drama may not be associated with any advertisements. Because a relationship exists between the hospital drama and the police drama, advertisements associated with the police drama may be relevant to the hospital drama as well (e.g., share a common viewer demographic). In this situation, the hospital drama may receive advertisement candidates from the police drama. Any number of advertisement candidates can be selected for a particular video.

In some implementations, advertisement candidates are selected from multiple related videos. For example, if viewers of a news parody also tend to view the hospital drama, the hospital drama can receive advertisement candidates from both the news parody and the hospital drama. In some implementations, a video may not share a relationship with any other videos which are associated with advertisements. In this situation, in some implementations, the video can receive advertisement candidates from a video which shares a relationship with a video which is associated with advertisements. For example, if the police drama is also not associated with advertisements, but a law drama associated to the police drama is associated with advertisements, the hospital drama may receive advertisement candidates from the law drama through the relationship with the police drama. Other relationship associations are possible.

The advertisers associated with the advertisement candidates are determined (step 608). Each advertisement (e.g., extracted during step 602) is matched to an advertiser. The matching can be done in any manual or automatic manner. For example, logo recognition, product recognition within closed-captioning text, file comparison, etc. can be used to relate an advertisement with the advertiser. In some implementations, advertisers may provide advertisements (e.g., within an advertisement repository) for matching purposes. The relationship between advertisements and advertisers can be stored, for example, within a relational database management system (RDBMS).

Using the relationships between the advertisements and the advertisers, the advertisers associated with the candidate advertisements can be determined. For example, the hospital drama may have received two advertisement candidates from the law drama. The first advertisement candidate, for example, may provide information regarding a cough medicine. The cough medicine advertisement may have been matched to a drug company advertiser. Similarly, the second advertisement candidate may, for example, include information regarding a stage performance. The stage performance advertisement may have been matched to a theater group.

The best video matches are presented to an advertiser (step 610). The advertiser, for example, could be using an automated program to bid on placing advertisements within videos. In one example, the advertiser is a theater group. Because one of the theater group's advertisements is associated with the police drama and the police drama shares a relationship with the hospital drama, the advertiser can be presented with the hospital drama as a match for advertisement placement. Any number of videos can be presented to an advertiser as a potential demographic match.

The presentation of one or more advertisements with the video(s) is enabled based upon instructions from the advertiser associated with the advertisement(s) (step 612). In one example, the theater group chooses to enable advertisement presentment with the hospital drama. The advertiser, in some implementations, can also choose an advertisement to associate with the video. For example, if the advertisement associated with the police drama contains reference to a performance for a previous season, the theater group may choose to associate a different advertisement with the hospital drama (e.g., containing reference to an upcoming or current performance). In some implementations, the advertiser can enable presentation of more than one advertisement with a particular video or enable a single advertisement to be presented more than one time during the presentment of the video. For example, the drug company advertiser may choose to associate both a cough medicine advertisement and a pain relief medicine advertisement with the hospital drama.

In addition to enabling the presentation of advertisements with a video, the advertiser, in some implementations, may provide guidelines in presenting the advertisements. For example, the advertiser could select a position for the advertisement within the timeframe of the video presentment (e.g., before, during, after, etc.) or within the visual layout of the video presentment (e.g., banner, crawler, etc.). Other advertiser instructions are possible.

The steps within the process 600 may, in some implementations, occur in a different order, and/or one or more steps could be excluded. For example, the association between advertisers and advertisements could be determined at the time of advertisement extraction. In another example, the relationship between videos could be determined prior to advertisement extraction. In one example, information such as that found within the video viewer information data 200 could be used to generate the graph of relationships (e.g., graph 450 in FIG. 4B) between videos. Information such as that found within the advertisement presentment information data 250, for example, could be used to present best matches to an advertiser.

Although the steps in the process 600 have been presented linearly, the steps may occur in more than one communication or computing session or otherwise asynchronously. For example, steps 602 to 606 may occur in one session; advertisers may be determined and the selected advertisement may be presented to the determined advertisers in another session (step 608 and 610). In yet another communication or computing session, the advertisement may be placed within the video (or the advertisement is otherwise enabled to be presented with the videos) (step 612).

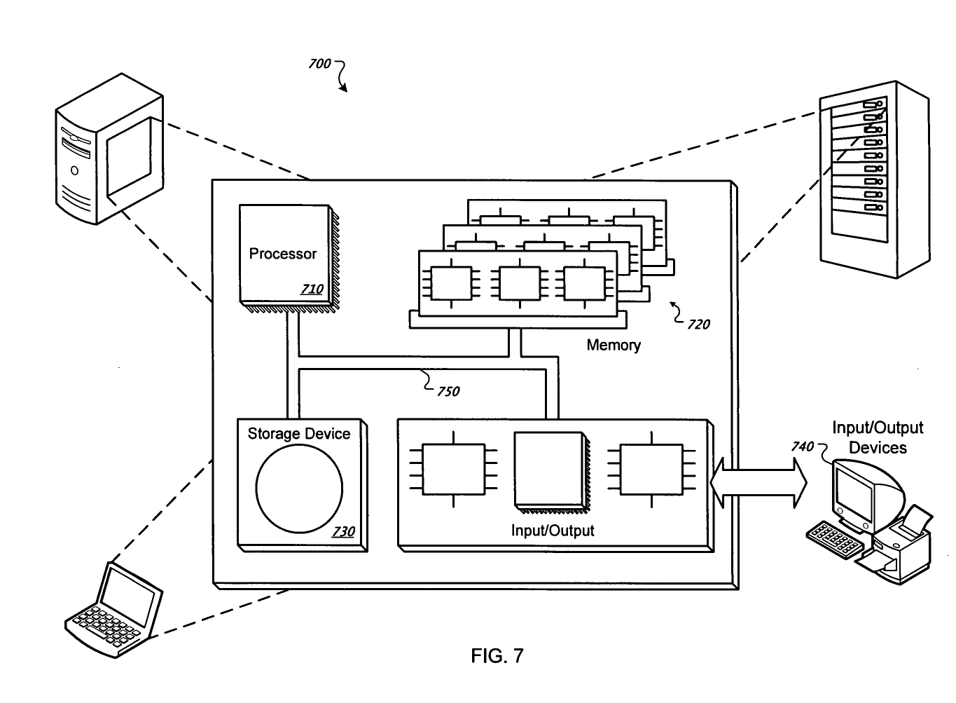

FIG. 7 is a schematic diagram of an example of a generic computer system 700. The system 700 can be used for the operations described in association with the method 300 according to one implementation. For example, the system 700 may be included in either or all of the advertisement system 102, the content provider 104, and the user device 106.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, the advertisement system 102 and the content provider 104 may be implemented within the same computer system.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations have been described. Nevertheless, it will be understood that various modifications may be made. For example, various forms of the flows shown above may be used, with steps re-ordered, added, or removed. Other implementations are within the scope of the following claims.

What is claimed is:

1. A computer system for selecting an advertisement, the system comprising:
a data store for advertisement presentment information including information that identifies advertisements that have been presented with videos and that enables identification of one or more advertisements that have been presented with a video to be identified;
a data store for video viewer information that enables identification of two or more videos that have been viewed by same viewers; and
instructions, that when executed by the computer system, cause the computer system to perform operations comprising:
receive a request to select an advertisement to be presented with a first video;
access the data store for video viewer information to identify a second video that has been viewed by at least one viewer of the first video;
access the data store for advertisement presentment information to identify an advertisement that has been presented with the second video; and
select the identified advertisement to be presented with the first video.

2. The computer system of claim 1 wherein identifying a second video that has been viewed by at least one viewer of the first video comprises identifying a second video that has been viewed by more viewers of the first video than other videos that have been viewed by at least one viewer of the first video.

3. The computer system of claim 1, wherein the advertisement comprises a first advertisement, further comprising instructions, that when executed by the computer system, cause the computer system to perform operations comprising:
access the data store for video viewer information to identify a third video that has been viewed by at least one viewer of the first video;
access the data store for advertisement presentment information to identify a second advertisement that has been presented with the third video;
identifying the first advertisement for presentation with the first video conditioned upon a determination that the second video has been viewed by more viewers of the first video than the third video.

4. The computer system of claim 1, wherein the advertisement comprises a first advertisement, further comprising instructions, that when executed by the computer system, cause the computer system to perform operations comprising:
access the data store for video viewer information to identify a third video that has been viewed by at least one viewer of the first video;
access the data store for advertisement presentment information to identify a second advertisement that has been presented with the third video;
assigning a first viewer-strength value to the second video wherein the first viewer-strength value represents a number of viewers who viewed both the second video and the first video;
assigning a second viewer-strength value to the third video wherein the second viewer-strength value represents a number of viewers who viewed both the third video and the first video;
identifying the first advertisement for presentation with the first video based on the first viewer-strength value and the second viewer-strength value.

5. The computer system of claim 4 further comprising instructions, that when executed by the computer system, cause the computer system to perform operations comprising:
determining a first normalizing value by dividing the number of viewers who viewed both the third video and the first video by the number of viewers who viewed either the third video and the first video;
determining a second normalizing value by dividing the number of viewers who viewed both the second video and the first video by the number of viewers who viewed either the second video and the first video;
identifying the first advertisement for presentation with the first video based on a ratio of the second viewer-strength value to the second normalizing value;
identifying the second advertisement for presentation with the first video based on a ratio of the third viewer-strength value to the first normalizing value.

6. The computer system of claim 1 further comprising instructions, that when executed by the computer system, cause the computer system to perform operations comprising enabling presentation of the selected advertisement with the first video.

7. The computer system of claim 1 wherein:
accessing the data store for advertisement presentment information to identify an advertisement comprises accessing the data store for advertisement presentation to identify advertisements that has been presented with the second video, and selecting the identified advertisement to be presented with the first video comprises selecting one or more of the identified advertisements to be presented with the first video based on a number of available advertising slots associated with the first video.

8. The computer system of claim 1, wherein accessing the data store for advertisement presentment information to identify an advertisement comprises accessing the data store for advertisement presentation to identify advertisements that has been presented with the second video,
further comprising instructions, that when executed by the computer system, cause the computer system to associate a value with each of the identified advertisements, the value representing a number of times the advertisement has been presented with the second video,
wherein selecting the identified advertisement to be presented with the first video comprises selecting one or more of the identified advertisements to be presented with the first video based on number of times the advertisement has been presented with the second video.

9. The computer system of claim 1 further comprising instructions, that when executed by the computer system, cause the computer system to perform operations comprising:
extracting an advertisement from a third video; and
modifying the advertisement presentment information to reflect information about the extracted advertisement.

10. The computer system of claim 9 wherein modifying the advertisement presentment information comprises matching the extracted advertisement to an advertisement in the advertisement presentment information.

11. The computer system of claim 9 further comprising instructions, that when executed by the computer system, cause the computer system to perform operations comprising:
identifying the first video to an advertiser associated with selected advertisement, enabling presentation of the selected advertisement with the first video only after the advertiser indicates the selected advertisement is to be presented with the first video.

12. A computer-implemented method for selecting an advertisement, the method comprising:
receiving a request to select an advertisement to be presented with a first video;
identifying a second video that has been viewed by at least one viewer of the first video;
identifying an advertisement that has been presented with the second video; and select the identified advertisement to be presented with the first video.

13. A computer-implemented method comprising: receiving a request to select sponsored content to be presented with a first content item including video;
identifying a second content item including video, where the video included in the second content item has been viewed by at least one viewer of the video included in the first content item;
identifying sponsored content that has been presented with the second content item; and
selecting the identified sponsored content to be presented with the first content item.

14. The method of claim 13 wherein identifying a second content item comprises identifying a second content item including video, where the video included in the second content item has been viewed by more viewers of the video of the first content item than videos that have been viewed by at least one viewer of the first content item.

15. The method of claim 13, wherein the sponsored content comprises a first sponsored content item, further comprising:
accessing video viewer information to identify a third content item including video that has been viewed by at least one viewer of the first video including in the first content item;
accessing sponsored-content presentment information to identify a second sponsored content item that has been presented with the third content item including video;
assigning a first viewer-strength value to the second video wherein the first viewer-strength value represents a number of viewers who viewed both the second content item including video and the first content item including video;
assigning a second viewer-strength value to the third content item including video wherein the second viewer-strength value represents a number of viewers who viewed both the third content item including video and the first content item including video; identifying the first sponsored content item for presentation with the first content item including video based on the first viewer-strength value and the second viewer-strength value.

16. A computer-implemented method comprising: accessing, from computer-accessible storage, information defining a graph representing relationships between videos, the graph comprising:
nodes wherein a node represents a video and one or more of the nodes are associated with one or more advertisements;
edges wherein an edge is connected to two videos and represents a number of viewers who saw both videos to which the edge is connected;
using the graph to associate an advertisement with a first node based on the advertisement being associated with a second node that is connected by an edge with the first node.

17. The method of claim 16 where using the graph to associate an advertisement with a first node comprises searching the graph using a breadth-first search technique.

18. A computer system comprising:
means for receiving a request to select sponsored content to be presented with a first content item including video;
means for identifying a second content item including video, where the video included in the second content item has been viewed by at least one viewer of the video included in the first content item;
means for identifying sponsored content that has been presented with the second content item; and
means for selecting the identified sponsored content to be presented with the first content item.
